(19) United States
(12) Patent Application Publication
(10) Pub. No.: US 2017/0002243 A1
(43) Pub. Date: Jan. 5, 2017

(54) Lubricant for Low Global Warming Potential Refrigerant Systems

(71) Applicant: THE LUBRIZOL CORPORATION, Wickliffe, OH (US)

(72) Inventors: Micheal I. Porter, Bay City, MI (US); Mark R. Baker, Midland, MI (US); Joseph A. Karnaz, Midland, MI (US); Michael G. Foster, Midland, MI (US); Kenneth C. Lilje, Las Cruces, NM (US)

(21) Appl. No.: 15/110,463

(22) PCT Filed: Jan. 8, 2015
(86) PCT No.: PCT/US2015/010558

§ 371 Date: Jul. 8, 2016

Related U.S. Application Data
(60) Provisional application No. 61/925,704, filed on Jan. 10, 2014.

(51) Int. Cl. C09K 5/04; C10M 111/04; C10M 171/00; C10M 105/38; C10M 111/02

(52) U.S. Cl. CPC C09K 5/045; C10M 105/38; C10M 111/02; C10M 171/008; C10M 111/04; C10M 2203/065; C10M 2203/024; C10M 2207/2835; C10M 2209/1033; C10N 2220/028; C10N 2220/302; C10N 2240/30; C09K 2205/122

(57) ABSTRACT

The disclosed technology relates to a working fluid for a low global warming potential (GWP) refrigeration system that includes a compressor, where the working fluid includes an ester based lubricant and a low GWP refrigerant, and where the ester based lubricant includes an ester of one or more branched carboxylic acids where said branched carboxylic acid contains 8 or less carbon atoms. The disclosed technology provides commercially useful low GWP working fluids (commercially useful working fluids based on low GWP refrigerants) that do not have the solubility and/or miscibility problems commonly seen in low GWP fluids, including high viscosity fluids and applications.

The disclosed technology relates to a working fluid for a low global warming potential (GWP) refrigeration system that includes a compressor, where the working fluid includes an ester based lubricant and a low GWP refrigerant, and where the ester based lubricant includes an ester of one or more branched carboxylic acids where said branched carboxylic acid contains 8 or less carbon atoms. The disclosed technology provides commercially useful low GWP working fluids (commercially useful working fluids based on low GWP refrigerants) that provide the necessary solubility and/or miscibility for use in low GWP fluids, including high viscosity fluids and applications.

### BACKGROUND OF THE INVENTION

Mechanical refrigeration systems, and related heat transfer devices such as heat pumps and air conditioners, using refrigerant fluids are well known in the art for industrial, commercial and domestic uses. Fluorocarbon based fluids have found widespread use in many residential, commercial and industrial applications, including as the working fluid in systems such as air conditioning, heat pump and refrigeration systems. Because of certain suspected environmental problems, including the relatively high global warming potentials associated with the use of some of the compositions that have heretofore been used in these applications, it has become increasingly desirable to use fluids having low or even zero ozone depletion potential, such as hydrofluorocarbons (“HFCs”). Furthermore, a number of governments have signed the Kyoto Protocol to protect the global environment setting forth a reduction of carbon dioxide emissions (global warming). Thus, there is a need for a low- or non-flammable, non-toxic alternative to replace certain high global warming potential HFCs.

There has thus been an increasing need for new fluorocarbon and hydrofluorocarbon compounds and compositions that are attractive alternatives to the compositions heretofore used in these and other applications. With regard to efficiency in use, it is important to note that a loss in refrigerant thermodynamic performance or energy efficiency may have secondary environmental impacts through increased fossil fuel usage arising from an increased demand for electrical energy. Furthermore, it is generally considered desirable for HFC refrigerant substitutes to be effective without major engineering changes to conventional vapor compression technology currently used with HFC refrigerants. Flammability is another important property for many applications. That is, it is considered either important or essential in many applications, including particularly in heat transfer applications, to use compositions which are non-flammable or have only mild flammability. Thus, it is frequently beneficial to use in such compositions compounds which are mildly flammable, or even less flammable than mildly flammable. As used herein, the term “mildly flammable” refers to compounds or compositions which are classified as being 2 L in accordance with ASHRAE standard 34 dated 2010, incorporated herein by reference. Unfortunately, some compounds which might otherwise be desirable for used in refrigerant compositions are flammable and classified as 2 and 3 by ASHRAE. For example, the fluoroalkane difluoroethane (HFC-152a) is flammable A2 and therefore not viable for use in neat form in many applications.

As the industry has attempted to meet this need, and to provide commercially useful low global warming potential working fluids, it has been found that low global warming potential (GWP) refrigerants have different solubility and miscibility characteristics than traditional HFC refrigerants. As such, many solubility and miscibility problems occur when conventional lubricants that are typically used with HFC refrigerants are now used with low GWP refrigerants. Conventional lubricants, including conventional PolyolEster (POE) based lubricants, do not provide the miscibility/solubility properties needed to enable these new refrigerant chemistries, such as R-32, to perform satisfactorily and meet the system performance requirements set forth by the hardware manufacturers. Thus the working fluids based on these low GWP refrigerants are difficult to use and do not perform as well as required, especially when a higher viscosity working fluid is needed since miscibility problems become more pronounced. Higher viscosity fluids are required by some hardware to provide adequate bearing durability and wear protection.

There is an ongoing need for commercially useful low GWP working fluids (commercially useful working fluids based on low GWP refrigerants) that do not have the solubility and/or miscibility problems commonly seen in such fluids, and the need is particular great for higher viscosities fluids and applications.

### SUMMARY OF THE INVENTION

The disclosed technology provides a working fluid for a low global warming potential (GWP) refrigeration system that includes a compressor, where the working fluid includes an ester based lubricant and a low GWP refrigerant, and where the ester based lubricant includes an ester of one or more branched carboxylic acids where said branched carboxylic acid contains 8 or less carbon atoms.

The disclosed technology provides the described working fluid where the branched carboxylic acid contains at least 5 carbon atoms. The disclosed technology provides the described working fluid where the branched carboxylic acid contains from 5 to 8 carbon atoms. The disclosed technology provides the described working fluid where the branched carboxylic acid contains 5 carbon atoms.

The disclosed technology provides the described working fluid where the branched carboxylic acid includes 2-methylbutanoic acid, 3-methylbutanoic acid, or a combination thereof.

The disclosed technology provides the described working fluid where the ester is formed by the reaction of the described acid and one or more polyols, where the polyol includes neopentyl glycol, glycerol, trimethylol propane, pentaerythritol, dip entaerythritol, trip entaerythritol.

The disclosed technology provides the described working fluid where the working fluid further includes: (i) one or more esters of one or more linear carboxylic acids, (ii) one or more polyalphaolefin (PAO) base oils, (iii) one more alkyl benzene base oils, (iv) one or more polyalkylene glycol (PAG) base oils, and/or (v) one or more alkylated naphthalene base oils, in combination with said ester of one or more branched carboxylic acids where said branched carboxylic acid contains 8 or less carbon atoms.

The disclosed technology provides the described working fluid where the low GWP refrigerant comprises R-32, R-290, R-1234yf, R-1234ze(E), R-744, R-152a, R-600, R-600a, or any combination thereof.

The disclosed technology provides the described working fluid where the described low GWP refrigerant has a GWP value (as calculated per the

Intergovernmental Panel on Climate Change's 2001 Third Assessment Report) of not greater than about 1000. The disclosed technology also provides the described working fluid where the described low GWP refrigerant has a GWP value of less than 1000, less than 500, less than 150, less than 100, or even less than 75. In some embodiments, this GWP value is with regards to the overall working fluid. In other embodiments, this GWP value is with regards to the refrigerant present in the working fluid, where the resulting working fluid may be referred to as a low GWP working fluid.

The disclosed technology provides the described working fluid, where the fluid further includes a non-low GWP refrigerant blended with the said low GWP refrigerant, resulting in a working fluid that may still be referred to as a low GWP working fluid.

The disclosed technology further provides a refrigeration system that includes a compressor and a working fluid, where the working fluid includes an ester based lubricant and a low GWP refrigerant, where the ester based lubricant includes an ester of one or more branched carboxylic acids where said branched carboxylic acid contains 8 or less carbon atoms.

The described refrigeration system may utilize any of the working fluids described herein, including but not limited to the described working fluid where the branched carboxylic acid contains at least 5 carbon atoms, or 5 to 8 carbon atoms, or even 5 carbon atoms.

The described refrigeration system may utilize any of the working fluids described herein, including but not limited to the described working fluid where: (i) the branched carboxylic acid includes 2-methylbutanoic acid, 3-methylbutanoic acid, or a combination thereof; (ii) where the ester is formed by the reaction of said acid and one or more polyols, wherein said polyol includes neopentyl glycol, glycerol, trimethylol propane, pentaerythritol, dip entaerythritol, trip entaerythritol; and (iii) where said low GWP refrigerant comprises R-32, R-290, R-1234yf, R-1234ze(E), R-744, R-152a, R-600, R-600a, or any combination thereof.

The described refrigeration system may utilize any of the working fluids described herein, including but not limited to the described working fluid where the low GWP refrigerant has a GWP value of less than 1000, less than 500, less than 150, less than 100, or even less than 75. In some embodiments, this GWP value is with regards to the overall working fluid. In other embodiments, this GWP value is with regards to the refrigerant present in the working fluid, where the resulting working fluid may be referred to as a low GWP working fluid.

The described refrigeration system may utilize any of the working fluids described herein, including but not limited to the described working fluid where the working fluid further includes a non-low GWP refrigerant, such as R-134a, blended with the said low GWP refrigerant, resulting in a working fluid that may still be referred to as a low GWP working fluid.

The disclosed technology further provides a method of operating a refrigeration system that utilizes a low GWP refrigerant, said method including the step of: (I) supplying to said refrigeration system a working fluid comprising an ester based lubricant and a low GWP refrigerant; where the ester based lubricant includes an ester of one or more branched carboxylic acids where said branched carboxylic acid contains 8 or less carbon atoms. The described methods may utilize any of the refrigeration systems described herein, and may utilize any of the working fluids described herein.

The disclosed technology further provides the use of an ester of one or more branched carboxylic acids in combination with a low GWP refrigerant as a working fluid for a refrigerant system where said branched carboxylic acid contains 8 or less carbon atoms.

### DETAILED DESCRIPTION OF THE INVENTION

Various preferred features and embodiments will be described below by way of non-limiting illustration.

The disclosed technology further provides a working fluid for a low global warming potential (GWP) refrigeration system that includes a compressor. The working fluid includes an ester based lubricant and a low GWP refrigerant.

The ester based lubricant includes an ester of one or more branched carboxylic acids where said branched carboxylic acid contains 8 or less carbon atoms. The ester is generally formed by the reaction of the described branched carboxylic acid and one or more polyols.

In some embodiments, the branched carboxylic acid contains at least 5 carbon atoms. In some embodiments, the branched carboxylic acid contains from 5 to 8 carbon atoms. In some embodiments, the branched carboxylic acid contains 5 carbon atoms. In any of these embodiments, the branched carboxylic acid may be free of acids containing 9 carbon atoms. In any of these embodiments, the branched carboxylic acid may be free of 3,5,5-trimethylhexanoic acid.

In some embodiments, the branched carboxylic acid, from which the ester is derived, includes 2-methylbutanoic acid, 3-methylbutanoic acid, or a combination thereof. In some embodiments, the branched carboxylic acid, from which the ester is derived, includes 2-methylbutanoic acid. In some embodiments the branched carboxylic acid, from which the ester is derived, includes 3-methylbutanoic acid. In some embodiments, the branched carboxylic acid, from which the ester is derived, includes a combination of 2-methylbutanoic acid and 3-methylbutanoic acid.

In some embodiments, the polyol used in the preparation of the ester includes neopentyl glycol, glycerol, trimethylol propane, pentaerythritol, dipentaerythritol, tripentaerythritol, or any combination thereof. In some embodiments, the polyol used in the preparation of the ester includes neopentyl glycol, pentaerythritol, dipentaerythritol, or any combination thereof. In some embodiments, the polyol used in the preparation of the ester includes neopentyl glycol. In some embodiments, the polyol used in the preparation of the ester includes pentaerythritol. In some embodiments, the polyol used in the preparation of the ester includes dipentaerythritol.

In some embodiments, the ester is derived from (i) an acid that includes 2-methylbutanoic acid, 3-methylbutanoic acid, or a combination thereof; and (ii) a polyol that includes neopentyl glycol, glycerol, trimethylol propane, pentaerythritol, dipentaerythritol, tripentaerythritol, or any combination thereof.

In some embodiments, the ester is derived from (i) an acid that includes 2-methylbutanoic acid; and (ii) a polyol that includes neopentyl glycol, glycerol, trimethylol propane, pentaerythritol, dip entaerythritol, trip entaerythritol, or any combination thereof. In some embodiments, the ester is derived from (i) an acid that includes 3-methylbutanoic acid; and (ii) a polyol that includes neopentyl glycol, glycerol, trimethylol propane, pentaerythritol, dipentaerythritol, tripentaerythritol, or any combination thereof.

In some embodiments, the ester is derived from (i) an acid that includes 2-methylbutanoic acid; and (ii) a polyol that includes pentaerythritol.

In some embodiments, the ester is derived from (i) an acid that includes 2-methylbutanoic acid; and (ii) a polyol that includes dipentaerythritol.

In some embodiments, the ester is derived from (i) an acid that includes 3-methylbutanoic acid; and (ii) a polyol that includes pentaerythritol.

In some embodiments, the ester is derived from (i) an acid that includes 3-methylbutanoic acid; and (ii) a polyol that includes dipentaerythritol.

In some embodiments, the ester is derived from (i) an acid that includes 2-methylbutanoic acid; and (ii) a polyol that includes neopentyl glycol.

It is noted that a key feature of the disclosed technology is the ability to provide a high viscosity low GWP working fluid that has good miscibility.

By “high viscosity” it is meant the ester based lubricant and/or the working fluid has a viscosity (as measured by ASTM D445 at 40 degrees C.) of more than 22, or even more than 32 cSt. In some embodiments, the ester based lubricant and/or the working fluid has a viscosity at 40 C from 22 or even 32 up to 220, 120, or even 68 cSt.

As noted by above, by “low GWP”, it is meant the working fluid has a GWP value (as calculated per the Intergovernmental Panel on Climate Change's 2001 Third Assessment Report) of not greater than about 1000, or a value that is less than 1000, less than 500, less than 150, less than 100, or even less than 75. In some embodiments, this GWP value is with regards to the overall working fluid. In other embodiments, this GWP value is with regards to the refrigerant present in the working fluid, where the resulting working fluid may be referred to as a low GWP working fluid.

By “good miscibility” it is meant that the refrigerant and lubricant are miscible, at least at the conditions the described working fluid will see during the operation of a refrigeration system. In some embodiments, good miscibility can mean that the working fluid (and/or the combination of refrigerant and lubricant) does not show any signs of poor miscibility other than visual haziness at temperatures as low as 0 C, or even −5 C, or even in some embodiments as low as −20 C, or even −25 C.

In some embodiments, the described working fluid may further include one or more additional lubricant components. These additional lubricant components may include (i) one or more esters of one or more linear carboxylic acids, (ii) one or more polyalphaolefin (PAO) base oils, (iii) one more alkyl benzene base oils, (iv) one or more polyalkylene glycol (PAG) base oils, (iv) one or more alkylated naphthalene base oils, or (v) any combination thereof.

Additional lubricants that may be used in the described working fluids include certain silicone oils and mineral oils.

Commercially available mineral oils include Sonneborn® LP 250 commercially available from Sonneborn, Suniso® 3GS, 1GS, 4GS, and 5GS, each commercially available from Sonneborn, and Calumet R015 and R030 commercially available from Calumet. Commercially available alkyl benzene lubricants include Zerol® 150 and Zerol® 300 commercially available from Shrieve Chemical. Commercially available esters include neopentyl glycol dipelargonate, which is available as Emery® 2917 and Hatcol® 2370. Other useful esters include phosphate esters, dibasic acid esters, and fluoroesters. Of course, different mixtures of different types of lubricants may be used.

In some embodiments, the described working fluid further includes one or more esters of one or more linear carboxylic acids.

The working fluids of the invention also include one or more refrigerants.

At least one of the refrigerants is a low GWP refrigerant. In some embodiments, all of the refrigerants present in the working fluid are low GWP refrigerants. In some embodiments, the refrigerant includes R-32, R-290, R-1234yf, R-1234ze(E), R-744, R-152a, R-600, R-600a or any combination thereof. In some embodiments, the refrigerant includes R-32, R-290, R-1234yf, R-1234ze(E) or any combination thereof. In some embodiments, the refrigerant includes R-32. In some embodiments the refrigerant includes R-290. In some embodiments, the refrigerant includes R-1234yf. In some embodiments, the refrigerant includes R-1234ze(E). In some embodiments, the refrigerant includes R-744. In some embodiments, the refrigerant includes R-152a. In some embodiments, the refrigerant includes R-600. In some embodiments, the refrigerant includes R-600a.

In some embodiments, the refrigerant includes R-32, R-600a, R-290, DR-5, DR-7, DR-3, DR-2, R-1234yf, R-1234ze(E), XP-10, HCFC-123, L-41A, L-41B, N-12A, N-12B, L-40, L-20, N-20, N-40A, N-40B, ARM-30A, ARM-21A, ARM-32A, ARM-41A, ARM-42A, ARM-70A, AC-5, AC-5X, HPR1D, LTR4X, LTR6A, D2Y-60, D4Y, D2Y-65, R-744, R-1270, or any combination thereof. In some embodiments, the refrigerant includes R-32, R-600a, R-290, DR-5, DR-7, DR-3, DR-2, R-1234yf, R-1234ze(E), XP-10, HCFC-123, L-41A, L-41B, N-12A, N-12B, L-40, L-20, N-20, N-40A, N-40B, ARM-30A, ARM-21A, ARM-32A, ARM-41A, ARM-42A, ARM-70A, AC-5, AC-5X, HPR1D, LTR4X, LTR6A, D2Y-60, D4Y, D2Y-65, R-1270, or any combination thereof.

It is noted that the described working fluids may in some embodiments also include one or more non-low GWP refrigerant, blended with the low GWP refrigerant, resulting in a low GWP working fluid. Suitable non-low GWP refrigerants useful in such embodiments are not overly limited. Examples include R-22, R-134a, R-125, R-143a, or any combination thereof.

The described working fluids, at least in regards to how they would be found in the evaporator of the refrigeration system in which they are used, may be from about 5 to about 50 percent by weight lubricant, and from 95 to 50 percent by weight refrigerant. In some embodiments, the working fluid is from 10 to 40 percent by weight lubricant, or even from 10 to 30 or 10 to 20 percent by weight lubricant.

The described working fluids, at least in regards to how they would be found in the sump of the refrigeration system in which they are used, may be from about 1 to 50, or even 5 to 50 percent by weight refrigerant, and from 99 to 50 or even 95 to 50 percent by weight lubricant. In some embodiments, the working fluid is from 90 to 60 or even 95 to 60 percent by weight lubricant, or even from 90 to 70 or even 95 to 70, or 90 to 80 or even 95 to 80 percent by weight lubricant.

The described working fluids may include other components for the purpose of enhancing or providing certain functionality to the composition, or in some cases to reduce the cost of the composition.

The described working fluids may further include one or more performance additives. Suitable examples of performance additives include antioxidants, metal passivators and/or deactivators, corrosion inhibitors, antifoams, antiwear inhibitors, corrosion inhibitors, pour point depressants, viscosity improvers, tackifiers, metal deactivators, extreme pressure additives, friction modifiers, lubricity additives, foam inhibitors, emulsifiers, demulsifiers, acid catchers, or mixtures thereof.

In some embodiments, the compositions of the present invention include an antioxidant. In some embodiments, the compositions of the present invention include a metal passivator, wherein the metal passivator may include a corrosion inhibitor and/or a metal deactivator. In some embodiments, the compositions of the present invention include a corrosion inhibitor. In still other embodiments, the compositions of the present invention include a combination of a metal deactivator and a corrosion inhibitor. In still further embodiments, the compositions of the present invention include the combination of an antioxidant, a metal deactivator and a corrosion inhibitor. In any of these embodiments, the compositions may further include one or more additional performance additives.

The antioxidants suitable for use in the present invention are not overly limited. Suitable antioxidants include butylated hydroxytoluene (BHT), butylatedhydroxyanisole (BHA), phenyl-a-naphthylamine (PANA), octylated/butylated diphenylamine, high molecular weight phenolic antioxidants, hindered bis-phenolic antioxidant, di-alpha-tocopherol, di-tertiary butyl phenol.

Other useful antioxidants are described in U.S. Pat. No. 6,534,454 incorporated herein by reference

In some embodiments, the antioxidant includes one or more of:
(i) Hexamethylenebis(3 ,5 -di-tert-butyl-4-hydroxyhydrocinnamate), CAS registration number 35074-77-2, available commercially from BASF;
(ii) N-phenylbenzenamine, reaction products with 2,4,4-trimethylpentene, CAS registration number 68411-46-1, available commercially from BASF;
(iii) Phenyl-a-and/or phenyl-b-naphthylamine, for example N-phenyl-ar-(1,1,3,3-tetramethylbutyl)-1-naphthalenamine, available commercially from BASF;
(iv) Tetrakis[methylene(3,5-di-tent-butyl-4-hydroxyhydrocinnamate)] methane, CAS registration number 6683-19-8;
(v) Thiodiethylenebis (3,5-di-tent-butyl-4-hydroxyhydrocinnamate), CAS registration number 41484-35-9, which is also listed as thiodiethylenebis (3,5-di-tent-butyl-4-hydroxy-hydro-cinnamate) in 21 C.F.R. §178.3570;
(vi) Butylatedhydroxytoluene (BHT);
(vii) Butylatedhydroxyanisole (BHA),
(viii) Bis(4-(1,1,3,3-tetramethylbutyl)phenyl)amine, available commercially from BASF; and
(ix) Benzenepropanoic acid, 3,5-bis(1,1-dimethylethyl)-4-hydroxy-, thiodi-2,1-ethanediyl ester, available commercially from BASF.

The antioxidants may be present in the composition from 0.01% to 6.0% or from 0.02%, to 1%. The additive may be present in the composition at 1%, 0.5%, or less. These various ranges are typically applied to all of the antioxidants present in the overall composition. However, in some embodiments, these ranges may also be applied to individual antioxidants.

The metal passivators suitable for use in the present invention are not overly limited and may include both metal deactivators and corrosion inhibitors.

Suitable metal deactivators include triazoles or substituted triazoles. For example, tolyltriazole or tolutriazole may be utilized in the present invention. Suitable examples of metal deactivator include one or more of:
(i) One or more tolu-triazoles, for example N,N-Bis(2-ethylhexyl)-ar-methyl-1H-benzotriazole-l-methanamine, CAS registration number 94270-86-70, sold commercially by BASF under the trade name Irgamet 39;
(ii) One or more fatty acids derived from animal and/or vegetable sources, and/or the hydrogenated forms of such fatty acids, for example Neo-Fat™ which is commercially available from Akzo Novel Chemicals, Ltd.

Suitable corrosion inhibitors include one or more of:
(i) N-Methyl-N-(1-oxo-9-octadecenyl)glycine, CAS registration number 110-25-8;
(ii) Phosphoric acid, mono- and diisooctyl esters, reacted with tent-alkyl and (C12-C14) primary amines, CAS registration number 68187-67-7;
(iii) Dodecanoic Acid;
(iv) Triphenyl phosphorothionate, CAS registration number 597-82-0; and
(v) Phosphoric acid, mono- and dihexyl esters, compounds with tetramethylnonylamines and C 11-14 alkylamines.

In one embodiment, the metal passivator is comprised of a corrosion additive and a metal deactivator. One useful additive is the N-acyl derivative of sarcosine, such as an N-acyl derivative of sarcosine. One example is N-methyl-N-(1-oxo-9-octadecenyl) glycine. This derivative is available from BASF under the trade name SARKOSYL™ O. Another additive is an imidazoline such as Amine O™ commercially available from Ciba-Geigy.

The metal passivators may be present in the composition from 0.01% to 6.0% or from 0.02%, to 0.1%. The additive may be present in the composition at 0.05% or less. These various ranges are typically applied to all of the metal passivator additives present in the overall composition. However, in some embodiments, these ranges may also be applied to individual corrosion inhibitors and/or metal deactivators. The ranges above may also be applied to the combined total of all corrosion inhibitors, metal deactivators and antioxidants present in the overall composition.

The compositions described herein may also include one or more additional performance additives. Suitable additives include antiwear inhibitors, rust/corrosion inhibitors and/or metal deactivators (other than those described above), pour point depressants, viscosity improvers, tackifiers, extreme pressure (EP) additives, friction modifiers, foam inhibitors, emulsifiers, and demulsifiers.

To prevent wear on the metal surface, the present invention utilizes an anti-wear inhibitor/EP additive and friction modifier. Anti-wear inhibitors, EP additives, and friction modifiers are available off the shelf from a variety of vendors and manufacturers. Some of these additives can perform more than one task and any may be utilized in the present invention. One product that can provide anti-wear, EP, reduced friction and corrosion inhibition is phosphorus amine salt such as Irgalube 349, which is commercially available from BASF. Another anti-wear/EP inhibitor/friction modifier is a phosphorus compound such as is triphenyl phosphothionate (TPPT), which is commercially available from BASF under the trade name Irgalube TPPT. Another anti-wear/EP inhibitor/friction modifier is a phosphorus compound such as is tricresyl phosphate (TCP), which is commercially available from Chemtura under the trade name Kronitex TCP. Another anti-wear/EP inhibitor/friction modifier is a phosphorus compound such as is t-butylphenyl phosphate, which is commercially available from ICL Industrial Products under the trade name Syn-O-Ad 8478. The anti-wear inhibitors, EP, and friction modifiers are typically about 0.1% to about 4% of the composition and may be used separately or in combination.

In some embodiments, the composition further includes an additive from the group comprising: viscosity modifiers-including, but not limited to, ethylene vinyl acetate, polybutenes, polyisobutylenes, polymethacrylates, olefin copolymers, esters of styrene maleic anhydride copolymers, hydrogenated styrene-diene copolymers, hydrogenated radial polyisoprene, alkylated polystyrene, fumed silicas, and complex esters; and tackifiers like natural rubber solubilized in oils.

The addition of a viscosity modifier, thickener, and/or tackifier provides adhesiveness and improves the viscosity and viscosity index of the lubricant. Some applications and environmental conditions may require an additional tacky surface film that protects equipment from corrosion and wear. In this embodiment, the viscosity modifier, thickener/tackifier is about 1 to about 20 weight percent of the lubricant. However, the viscosity modifier, thickener/tackifier can be from about 0.5 to about 30 weight percent. An example of a material that can be used in this invention is Functional V-584 a Natural Rubber viscosity modifier/tackifier, which is available from Functional Products, Inc., Macedonia, Ohio. Another example is a complex ester CG 5000 that is also a multifunctional product, viscosity modifier, pour point depressant, and friction modifier from Inolex Chemical Co. Philadelphia, Pa.

Other oils and/or components may be also added to the composition in the range of about 0.1 to about 75% or even 0.1 to 50% or even 0.1 to 30%. These oils could include white petroleum oils, synthetic esters (as described in patent U.S. Pat. No. 6,534,454), severely hydro-treated petroleum oil (known in the industry as “Group II or III petroleum oils”), esters of one or more linear carboxylic acids, polyalphaolefin (PAO) base oils, alkyl benzene base oils, polyalkylene glycol (PAG) base oils, alkylated naphthalene base oils, or any combination thereof.

The disclosed technology also provides a refrigeration system, where the refrigeration system includes a compressor and a working fluid, where the working fluid includes an ester based lubricant and a low GWP refrigerant, where the ester based lubricant includes an ester of one or more branched carboxylic acids where said branched carboxylic acid contains 8 or less carbon atoms. Any of the working fluids described above may be used in the described refrigeration system.

The disclosed technology also provides a method of operating a refrigeration system, where the refrigeration system utilizes a low GWP refrigerant. The described method includes the step of: (I) supplying to the refrigeration system a working fluid that includes an ester based lubricant and a low GWP refrigerant, where the ester based lubricant includes an ester of one or more branched carboxylic acids where said branched carboxylic acid contains 8 or less carbon atoms. Any of the working fluids described above may be used in the described methods of operating any of the described refrigeration systems.

The disclosed technology also provides the use of an ester of one or more branched carboxylic acids, where said branched carboxylic acid contains 8 or less carbon atoms, in combination with a low GWP refrigerant as a working fluid for a refrigerant system. Any of the working fluids described above may be used in the described use, in any of the described refrigeration systems.

The present methods, systems and compositions are thus adaptable for use in connection with a wide variety of heat transfer systems in general and refrigeration systems in particular, such as air-conditioning (including both stationary and mobile air conditioning systems), refrigeration, heat-pump systems, and the like. In certain embodiments, the compositions of the present invention are used in refrigeration systems originally designed for use with an HFC refrigerant, such as, for example, R-410A or R-404A.

As used herein, the term “refrigeration system” refers generally to any system or apparatus, or any part or portion of such a system or apparatus, which employs a refrigerant to provide cooling and/or heating. Such refrigeration systems include, for example, air conditioners, electric refrigerators, chillers, heat pumps, and the like.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include:

hydrocarbon substituents, that is, aliphatic (e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

substituted hydrocarbon substituents, that is, substituents containing non-hydrocarbon groups which, in the context of this invention, do not alter the predominantly hydrocarbon nature of the substituent (e.g., halo (especially chloro and fluoro), hydroxy, alkoxy, mercapto, alkylmercapto, nitro, nitroso, and sulfoxy);

hetero substituents, that is, substituents which, while having a predominantly hydrocarbon character, in the context of this invention, contain other than carbon in a ring or chain otherwise composed of carbon atoms and encompass substituents as pyridyl, furyl, thienyl and imidazolyl. Heteroatoms include sulfur, oxygen, and nitrogen. In general, no more than two, or no more than one, non-hydrocarbon substituent will be present for every ten carbon atoms in the hydrocarbyl group; alternatively, there may be no non-hydrocarbon substituents in the hydrocarbyl group.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

The invention may be better understood with reference to the following non-limiting examples.

### EXAMPLES

A series of ester lubricants are prepared, suitable for use in working fluids that contain low GWP refrigerants. The table below summarizes the acid and polyol used in the preparation of each ester where PE is pentaerythritol, DiPE is di-pentaerythritol, NPG is neopentylglycol, 2-MeBu is 2-methylbutanoic acid, 3-MeBu is 3-methylbutanoic acid, nC5 is pentanoic acid, nC7 is heptanoic acid, nC8-10 is a mixture of octanoic acid and decanoic acid, and iC9 is 3,5,5-trimethylhexanoic acid.

TABLE 1
Ester Summary

| | Alcohols | | | Acids | | | | | |
|---|---|---|---|---|---|---|---|---|---|
| Ester ID | PE | DiPE | NPG | 2-MeBu | 3-MeBu | nC5 | nC7 | nC8-10 | iC9 |
| Ester A | X | | | X | | | | | |
| Ester B | | X | | X | | | | | |
| Ester C | X | | | | X | | | | |
| Ester D | | | X | X | | | | | |
| Ester E | X | | | X | | X | | | X |
| Ester F | X | | | X | X | X | | | X |
| Ester G | X | | | X | X | X | | | X |
| Ester H | X | | | X | X | X | | | X |
| Ester I | X | X | | | | X | X | | X |
| Ester J | X | X | | | | X | X | | X |
| Ester K | X | | | | | X | X | | |
| Ester L | X | | | | | X | X | | X |
| Ester M | X | X | | | | X | X | | X |
| Ester N | X | | X | | | X | X | X | |
| Ester O | X | | | | | X | X | | X |
| Ester P | X | | | | | X | | | |
| Ester Q | | X | | | | | X | X | X |
| Ester R | | X | | | | X | X | | X |
| Ester S | X | X | | | | | X | X | X |
| Ester T | X | X | | | | X | X | | X |

Each ester is prepared using an essentially identical process. The alcohols and acids for each ester, as indicated in the table above, are combined in stoichiometric ratios determined by considering the specific reactant used, the desired molecular weight of the ester, the amount of water expected from the reaction, where the acid is used in excess. The esters are stripped and washed and then analyzed, with the results summarized below.

Esters A to H are inventive examples in that they are esters of one or more branched carboxylic acids where said branched carboxylic acid contains 8 or less carbon atoms. Esters I to T are comparative examples in that they are not esters of one or more branched carboxylic acids where said branched carboxylic acid contains 8 or less carbon atoms.

TABLE 2
Ester Test Results¹

| | | | | | Hydroxyl |
|---|---|---|---|---|---|
| | Viscosity | | | | Number² |
| | 40° C. | Viscosity | Viscosity | TAN² | (mg KOH |
| Ester ID | (cSt) | 100° C. (cSt) | Index | (mg KOH/g) | eq/g) |
| Ester A | 27.06 | 5.43 | 64 | 0.030 | 1.3 |
| Ester B | 161.21 | 15.04 | 93 | 0.017 | 1.2 |
| Ester C | 40.7 | 5.52 | 55 | 0.067 | 1.9 |
| Ester D | 3.58 | 1.34 | N/A | 0.045 | 1.1 |
| Ester E | 17.33 | 3.77 | 106 | 0.026 | 2.8 |
| Ester F | 18.36 | 4.17 | 133 | 0.046 | 4.6 |
| Ester G | 28.66 | 4.55 | 48 | 0.032 | 1.4 |
| Ester H | 38.39 | 5.3 | 51 | 0.026 | 1.1 |
| Ester I | 72.3 | 9.8 | 120 | <0.04 | <4.5 |
| Ester J | 31.2 | 5.6 | 120 | <0.04 | <4.5 |
| Ester K | 18.9 | 4.2 | 120 | <0.04 | <4.5 |
| Ester L | 62 | 8.5 | 108 | <0.04 | <4.5 |
| Ester M | 46 | 7.1 | 113 | <0.04 | <4.5 |
| Ester N | 15.1 | 3.5 | 110 | <0.04 | <4.5 |
| Ester O | 33.7 | 5.9 | 110 | <0.04 | <4.5 |
| Ester P | 15.7 | 3.6 | 115 | <0.04 | <4.5 |
| Ester Q | 170 | 17 | 105 | <0.04 | <4.5 |
| Ester R | 230 | 19.5 | 120 | <0.04 | <4.5 |
| Ester S | 64.19 | 9 | 116 | <0.04 | <4.5 |
| Ester T | 100 | 12.5 | 119 | <0.04 | <4.5 |

¹The viscosity of each sample is measured by ASTM D445, the viscosity index is measured by ASTM D2270, the total acid number (TAN) is measured by ASTM D974, and the hydroxyl number is measured by ASTM E222.
²The TAN and hydroxyl numbers for Esters I to T were not tested, but are known to be below the limits shown based on previous experience with the materials.

Several of the esters prepared above are then blended with R-32 to evaluate their miscibility with low GWP refrigerants. The working fluid samples are then tested to determine the miscibility of ester and refrigerant, by measuring the lowest temperature at which the working fluids remains stable, that is the lowest temperature at which the ester and refrigerant in the working fluid sample are still miscible.

For the testing each working fluid is placed in a ⅜″×8″ glass tube. The tubes are cooled while phase change is monitored. Ratings are taken as the samples are cooled, with possible ratings including: “One Phase” indicating the working fluid sample is in one phase and so miscible; “Hazy” indicating the working fluid is still one phase, but the sample appears iridescent or translucent but still miscible; “Cloudy” indicating the working fluid appears thick, white, or milky, and while no distinct phase separation is visible, the sample is not miscible; “Two Phase” indicating the working fluid can be clearly distinguished as two separate phases and so is not miscible. The sample tubes are placed in a large cooling acetone bath. The temperature is lowed in 5° increments, and at each increment the samples are stabilized for at least 5-10 minutes before taking the reading. The lowest temperature at which the sample is still considered miscible is considered the “Last One Phase Miscible Temperature” (LOPMT) and the lower the temperature the better the miscibility, and so compatibility, of the working fluid (i.e. the better the miscibility, and so compatibility, of the ester and the refrigerant). The working fluids samples and test results collected are summarized in the table below.

Fluids 1 to 8, made from Esters A to H, are inventive examples in that they contains esters of one or more branched carboxylic acids where said branched carboxylic acid contains 8 or less carbon atoms. Fluids 9 to 14, made from Esters Ito T, are comparative examples in that they do not contain esters of one or more branched carboxylic acids where said branched carboxylic acid contains 8 or less carbon atoms.

TABLE 3
Working Fluid Samples

| | Ester | Ester | Ester | Ester | Ester | Ester | Ester | Ester | Ester | Ester | Ester | Ester | Ester | Ester | | |
|---|---|---|---|---|---|---|---|---|---|---|---|---|---|---|---|---|
| | A | B | C | D | E | F | G | H | I | J | K | L | M | N | R-32 | |
| Sample | (wt | (wt | (wt | (wt | (wt | (wt | (wt | (wt | (wt | (wt | (wt | (wt | (wt | (wt | (wt | LOPMT |
| ID | %) | %) | %) | %) | %) | %) | %) | %) | %) | %) | %) | %) | %) | %) | %) | (° C.) |
| Fluid 1 | 10 | | | | | | | | | | | | | | 90 | −45 |
| Fluid 2 | | 10 | | | | | | | | | | | | | 90 | −65 |
| Fluid 3 | | | 10 | | | | | | | | | | | | 90 | <−60 |
| Fluid 4 | | | | 10 | | | | | | | | | | | 90 | −89 |
| Fluid 5 | | | | | 10 | | | | | | | | | | 90 | −60 |
| Fluid 6 | | | | | | 10 | | | | | | | | | 90 | −60 |
| Fluid 7 | | | | | | | 10 | | | | | | | | 90 | −60 |
| Fluid 8 | | | | | | | | 10 | | | | | | | 90 | −60 |
| Fluid 9 | | | | | | | | | 10 | | | | | | 90 | Not |
| | | | | | | | | | | | | | | | | Misc |
| Fluid 10 | | | | | | | | | | 10 | | | | | 90 | 10 |
| Fluid 11 | | | | | | | | | | | 10 | | | | 90 | 5 |
| Fluid 12 | | | | | | | | | | | | 10 | | | 90 | 15 |
| Fluid 13 | | | | | | | | | | | | | 10 | | 90 | Not |
| | | | | | | | | | | | | | | | | Misc |
| Fluid 14 | | | | | | | | | | | | | | 10 | 90 | 10 |

The results show the described working fluids have good miscibility between the R-32 refrigerant and the esters. Fluids 1 to 7 all show good LOPMT's well below -40° C. In contrast, Fluids 9 to 14 all have very high LOPMT's, or even lacked miscibility at ambient conditions, as seen in Fluid 9 and Fluid 13.

To further demonstrate the technology, several blends of the esters described above are prepared where each blend is a 15:85 to 85:15 by weight blend of the esters used. The table below summarizes the blend examples.

TABLE 4
Blend Summary

| Blend ID | Ester A | Ester B | Ester D | Ester G | Ester H | Ester L | Ester O | Ester P | Ester Q | Ester R | Ester S | Ester T |
|---|---|---|---|---|---|---|---|---|---|---|---|---|
| Blend 1 | X | X | | | | | | | | | | |
| Blend 2 | | X | | | | | X | | | | | |
| Blend 3 | X | X | | | | | | | | | X | |
| Blend 4 | X | X | | | | X | | | | | | |
| Blend 5 | | | X | | | | | | | | | X |
| Blend 6 | | X | X | | | | | | | | | |
| Blend 7 | | | | X | X | | | | | | | |
| Blend 8 | | | | | | | | X | | X | | |
| Blend 9 | | | | | | X | | X | | | | |
| Blend 10 | | | | | | X | | | X | | | |

Several of the blends prepared above are then blended with R-32 to evaluate their miscibility with low GWP refrigerants, using the same preparation and testing procedures described above.

Fluids 1 to 8, made from Esters A to H, are inventive examples in that they contains esters of one or more branched carboxylic acids where said branched carboxylic acid contains 8 or less carbon atoms. Fluids 9 to 14, made from Esters Ito

T, are comparative examples in that they do not contain esters of one or more branched carboxylic acids where said branched carboxylic acid contains 8 or less carbon atoms.

TABLE 3
Working Fluid Samples

| Sample | Blend 1 | Blend 2 | Blend 3 | Blend 4 | Blend 5 | Blend 6 | Blend 7 | Blend 8 | Blend 9 | Blend 10 | R-32 | LOPMT |
|---|---|---|---|---|---|---|---|---|---|---|---|---|
| ID | (wt %) | (wt %) | (wt %) | (wt %) | (wt %) | (wt %) | (wt %) | (wt %) | (wt %) | (wt %) | (wt %) | (° C.) |
| Fluid 15 | 10 | | | | | | | | | | 90 | −35 |
| Fluid 16 | | 10 | | | | | | | | | 90 | −30 |
| Fluid 17 | | | 10 | | | | | | | | 90 | −25 |
| Fluid 18 | | | | 10 | | | | | | | 90 | −35 |
| Fluid 19 | | | | | 10 | | | | | | 90 | −20 |
| Fluid 20 | | | | | | 10 | | | | | 90 | −65 |
| Fluid 21 | | | | | | | 10 | | | | 90 | <−60 |
| Fluid 22 | | | | | | | | 10 | | | 90 | Not Misc |
| Fluid 23 | | | | | | | | | 10 | | 90 | 5 |
| Fluid 24 | | | | | | | | | | 10 | 90 | Not Misc |

The results show the described working fluids, even when the described ester is blended with other esters, have good miscibility between the R-32 refrigerant and the esters. Fluids 15 to 21, which all include one of the described esters blended with another ester, all show good LOPMT's well below -40° C. In contrast Fluids 22 to 24, which do not include any of the described esters, all have very high LOPMT's, or even lacked miscibility at ambient conditions, as seen in Fluid 22 and Fluid 24.

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

1. A working fluid for a low global warming potential refrigeration system comprising a compressor, the working fluid comprising an ester based lubricant and a low global warming potential refrigerant;
wherein the ester based lubricant comprises an ester of one or more branched carboxylic acids where said branched carboxylic acid contains 8 or less carbon atoms.

2. The working fluid of claim 1 wherein said branched carboxylic acid contains 5 carbon atoms.

3. The working fluid of claim 1 wherein said branched carboxylic acid comprises 2-methylbutanoic acid, 3-methylbutanoic acid, or a combination thereof.

4. The working fluid of claim 1 wherein said ester is formed by the reaction of said acid and one or more polyols, wherein said polyol comprises neopentyl glycol, glycerol, trimethylol propane, pentaerythritol, dipentaerythritol, tripentaerythritol.

5. The working fluid of claim 1 wherein said working fluid further comprises: (i) one or more esters of one or more linear carboxylic acids, (ii) one or more polyalphaolefin (PAO) base oils, (iii) one more alkyl benzene base oils, (iii) one or more polyalkylene glycol (PAG) base oils, (iv) one or more alkylated naphthalene base oils, or (v) any combination thereof, in combination with said ester of one or more branched carboxylic acids.

6. The working fluid of claim 1 wherein said low globral warming potential refrigerant comprises R-32, R-290, R-1234yf, R-1234ze(E), R-600, R-600a, R-152a, R-744, or any combination thereof.

7. The working fluid of claim 1 wherein said low global warming potential refrigerant has a Global Warming Potential (GWP) of not greater than about 1000.

8. The working fluid of claim 1 further comprising a non-low global warming potential refrigerant blended with the said low global warming potential refrigerant, resulting in a low global warming potential working fluid.

9. A refrigeration system comprising a compressor and a working fluid, where the working fluid comprises an ester based lubricant and a low global warming potential refrigerant;
wherein the ester based lubricant comprises an ester of one or more branched carboxylic acids where said branched carboxylic acid contains 8 or less carbon atoms.

10. The refrigeration system of claim 9 wherein said branched carboxylic acid contains 5 carbon atoms.

11. The refrigeration system of caim 9 wherein said branched carboxylic acid comprises 2-methylbutanoic acid, 3-methylbutanoic acid, or a combination thereof;
wherein said ester is formed by the reaction of said acid and one or more polyols, wherein said polyol comprises neopentyl glycol, glycerol, trimethylol propane, pentaerythritol, dipentaerythritol, tripentaerythritol; and
wherein said low global warming potential refrigerant comprises R-32, R-290, R-1234yf, R-1234ze(E), R-600, R-600a, R-152a, R-744, or any combination thereof.

12. The refrigeration system of claim 9 wherein said low global warming potential refrigerant has a Global Warming Potential (GWP) of not greater than about 1000.

13. The refrigeration system of claim 9 wherein working fluid further comprising a non-low global warming potential refrigerant blended with the said low global warming potential refrigerant, resulting in a low global warming potential working fluid.

14. A method of operating a refrigeration system that utilizes a low global warming potential refrigerant, said method comprising the step of: (I) supplying to said refrigeration system a working fluid comprising an ester based lubricant and a low global warming potential refrigerant;
wherein the ester based lubricant comprises an ester of one or more branched carboxylic acids where said branched carboxylic acid contains 8 or less carbon atoms.

15. The use of an ester of one or more branched carboxylic acids in combination with a low global warming potential refrigerant as a working fluid for a refrigerant system where said branched carboxylic acid contains 8 or less carbon atoms.
